(19) United States
(12) Patent Application Publication
(10) Pub. No.: US 2024/0428186 A1
(43) Pub. Date: Dec. 26, 2024

(54) AUTOMATED SYSTEM AND METHOD FOR DETECTING REAL-TIME SPACE OCCUPANCY OF INVENTORY WITHIN A WAREHOUSE

(71) Applicant: ATAI LABS PRIVATE LIMITED, Hyderabad, Telangana (IN)

(72) Inventors: KRISHNA KISHORE ANDHAVARAPU, Hyderabad (IN); LOVARAJU ALLU, Visakhapatnam (IN); DIWAKAR SATYANARAYANA DEVUPALLI, Visakhapatnam (IN); SRIKAR REDDY VUNDI, Hyderabad (IN); ASHOK POOLLA, Hyderabad (IN); SATISH CHANDRA GUNDA, Kurnool (IN); KISHOR ARUMILLI, Hyderabad (IN); GANGADHAR GUDE, Hyderabad (IN)

(21) Appl. No.: 18/700,327

(22) PCT Filed: Aug. 10, 2022
(86) PCT No.: PCT/IB2022/057467

§ 371 Date: Apr. 11, 2024

(30) Foreign Application Priority Data
Aug. 11, 2021 (IN) 202141036271

(51) Int. Cl. G06Q 10/087; G06V 10/25; G06V 10/764; G06V 10/82; G06V 20/52

(52) U.S. Cl. CPC G06Q 10/087; G06V 10/25; G06V 10/764; G06V 10/82; G06V 20/52

(57) ABSTRACT

Exemplary embodiments of the present disclosure are directed towards an automated system for detecting real-time space occupancy of inventory within a warehouse, comprising cameras configured to capture predetermined area within warehouse to obtain image data, cameras configured to deliver image data to first computing device and second computing device over network; and space occupancy detection module configured to analyse image data received to first computing device and second computing device from cameras, space occupancy detection module configured to read and to store image data received from cameras at regular intervals, space occupancy detection module configured to crop Region of Interest of image data and categorizes each pixel of image data to derive plurality of segmentation classes, space occupancy detection module configured to predict amount of space utilized from plurality of segmentation classes; and predictions are mapped to a warehouse layout, space occupancy detection module configured to deliver the warehouse layout to cloud server over the network.

### TECHNICAL FIELD

The disclosed subject matter relates generally to warehouse management. More particularly, the present disclosure relates to a system and method for detecting real-time space occupancy of inventory within a warehouse.

### BACKGROUND

Generally, warehouses are equipped with multiple entries and exit points (shutters) from which inventory or cargo is brought into or taken away from a warehouse. Warchousing is an important part of a logistics management system where the storage of finished goods and various raw materials are accommodated which provides an important economic benefit to the business as well as customers. Usually, the incoming inventory is processed at the shutter itself as it comes in and a surveyor documents all the necessary information of that shipment manually. Once the shipment is completely unloaded, a warehouse team determines the optimal storage space within the warehouse and depending on the physical makeup of the items, inventory can be stored directly on the floor, stacked together, or palletized units, whichever provides the most convenience without compromising the quality assurance. Once the inventory is placed in the warehouse, the surveyor measures the space occupied by that shipment and manually records that information for customer billing, and so forth. There are manual errors in the computation of space utilization as well as time to update the observations is not real-time as the process is manual. The recorded data is entered into the systems manually at a later point in time and which can also add to the errors.

Yet so many inefficiencies in the entire process because there is no clear view of space occupancy in the warehouse. Currently, most companies depend only on manual methods for monitoring the resources and cost optimization and there is no automated system available for detecting real-time space occupancy of the warehouse usage for higher management as most of the activities are manual and take time to reflect in the systems. To mitigate these issues there is a need to develop an automatic system and method to detect real-time space occupancy of inventory within the warehouse.

In the light of the aforementioned discussion, there exists a need for a system for detecting real-time space occupancy of inventory within the warehouse.

### SUMMARY

The following presents a simplified summary of the disclosure in order to provide a basic understanding of the reader. This summary is not an extensive overview of the disclosure and it does not identify key/critical elements of the invention or delineate the scope of the invention. Its sole purpose is to present some concepts disclosed herein in a simplified form as a prelude to the more detailed description that is presented later.

An objective of the present disclosure is directed towards a system and method to detect real-time space occupancy of inventory within the warehouse.

Another objective of the present disclosure is directed towards the system that uses an artificial intelligence and machine learning techniques with trained convolutional neural network models to automate the process of detecting the amount of space utilized by inventory within the warehouse at any given point of time.

Another objective of the present disclosure is directed towards the system that captures the entire region of the warehouse using one or more cameras.

Another objective of the present disclosure is directed towards the system that processes the captured region of the warehouse using the trained convolutional neural network to detect the real-time space occupancy of inventory in the warehouse.

Another objective of the present disclosure is directed towards the system that provides improved methods for space allocation in the warehouse.

Another objective of the present disclosure is directed towards the system that provides digitized evidence for future reference.

Another objective of the present disclosure is directed towards the system that eliminates the light dependency to determine the space utilization.

Another objective of the present disclosure is directed towards the system that automatically estimates/predicts the ground space occupied by inventory/cargo (at the desired unit level in square footage) using Computer Vision/Artificial Intelligence technology.

Another objective of the present disclosure is directed towards the system optimizes the camera count and providing more flexibility by using motorized cameras on railings, and drone fitted camera with pre-programmed flight path.

In an embodiment of the present disclosure, the system comprising a plurality of cameras configured to capture a predetermined area within a warehouse to obtain an image data, the plurality of cameras configured to deliver the image data to a first computing device and a second computing device over a network.

In another embodiment of the present disclosure, a space occupancy detection module configured to analyse the image data received to the first computing device and the second computing device from the plurality of cameras.

In another embodiment of the present disclosure, the space occupancy detection module comprising a pre-processor module configured to read the image data delivered by the plurality of cameras and stores the image data received from the plurality of cameras at regular intervals.

In another embodiment of the present disclosure, the space occupancy detection module comprising a classification module configured to monitor the pre-processor module for the image data using a watchdog observer module.

In another embodiment of the present disclosure, the classification module comprising a watchdog observer module configured to receive the stored image data from the pre-processor module and delivers the image data to a data classifier module.

In another embodiment of the present disclosure, the classification module comprising a data classifier module configured to perform one or more image processing techniques to the image data to classify an inventory kind stored in the predetermined area.

In another embodiment of the present disclosure, the data classifier module configured to crop Region of Interest of the image data and delivers to a deep learning module.

In another embodiment of the present disclosure, the classification module comprising the deep learning module comprising a semantic segmentation module configured to categorize each pixel of the image data to derive multiple segmentation classes, the semantic segmentation module configured to predict the amount of space utilized from the multiple segmentation classes.

In another embodiment of the present disclosure, the space occupancy detection module comprising a post-processor module configured to use one or more predictions of the semantic segmentation module to map the one or more predictions to a warehouse layout and delivers the warehouse layout to a cloud server over the network.

In another embodiment of the present disclosure, the system comprising a central database configured to store the image data captured by the plurality of cameras, the central database configured to store the one or more inventory kinds, and multiple segmentation classes, the warehouse layout derived by the space occupancy detection module.

### BRIEF DESCRIPTION OF THE DRAWINGS

In the following, numerous specific details are set forth to provide a thorough description of various embodiments. Certain embodiments may be practiced without these specific details or with some variations in detail. In some instances, certain features are described in less detail so as not to obscure other aspects. The level of detail associated with each of the elements or features should not be construed to qualify the novelty or importance of one feature over the others.

FIG. 1 is a block diagram representing a system in which aspects of the present disclosure can be implemented. Specifically, FIG. 1 depicts a schematic representation of the system for detecting real-time space occupancy of an inventory within a warehouse, in accordance with one or more exemplary embodiments.

FIG. 2A is an example diagram depicting a schematic representation of the warehouse, in accordance with one or more exemplary embodiments.

FIG. 2B is another example diagram depicting a schematic representation of the predetermined area being covered by cameras in the warehouse, in accordance with one or more exemplary embodiments.

FIG. 2C and FIG. 2D are example diagrams depicting the warehouse, in accordance with one or more exemplary embodiments.

FIG. 3A is an example diagram depicting a top view of the cameras in the warehouse, in accordance with one or more exemplary embodiments.

FIG. 3B is another example diagram depicting a side view of the cameras in the warehouse, in accordance with one or more exemplary embodiments.

FIG. 3C is another example diagram depicting a front view of the cameras in the warehouse, in accordance with one or more exemplary embodiments.

FIG. 4A is a block diagram depicting a schematic representation of the space occupancy detection module 114 shown in FIG. 1, in accordance with one or more exemplary embodiments.

FIG. 4B is a block diagram depicting a schematic representation of the classification module 404 shown in FIG. 1, in accordance with one or more exemplary embodiments.

FIG. 5 is another example of flow diagram depicting a method of a pre-processor module, in accordance with one or more exemplary embodiments.

FIG. 6 is another example of flow diagram depicting a method of a data classifier module, in accordance with one or more exemplary embodiments.

FIG. 7 is another example of flow diagram depicting a method of a post-processor module, in accordance with one or more exemplary embodiments.

FIG. 8 is another example of flow diagram depicting a method for detecting real-time space occupancy of an inventory within a warehouse, in accordance with one or more exemplary embodiments.

FIG. 9 is a block diagram illustrating the details of digital processing system in which various aspects of the present disclosure are operative by execution of appropriate software instructions.

### DETAILED DESCRIPTION OF EXAMPLE EMBODIMENTS

It is to be understood that the present disclosure is not limited in its application to the details of construction and the arrangement of components set forth in the following description or illustrated in the drawings. The present disclosure is capable of other embodiments and of being practiced or of being carried out in various ways. Also, it is to be understood that the phraseology and terminology used herein is for the purpose of description and should not be regarded as limiting.

The use of “including”, “comprising” or “having” and variations thereof herein is meant to encompass the items listed thereafter and equivalents thereof as well as additional items. The terms “a” and “an” herein do not denote a limitation of quantity, but rather denote the presence of at least one of the referenced item. Further, the use of terms “first”, “second”, and “third”, and the like, herein do not denote any order, quantity, or importance, but rather are used to distinguish one element from another.

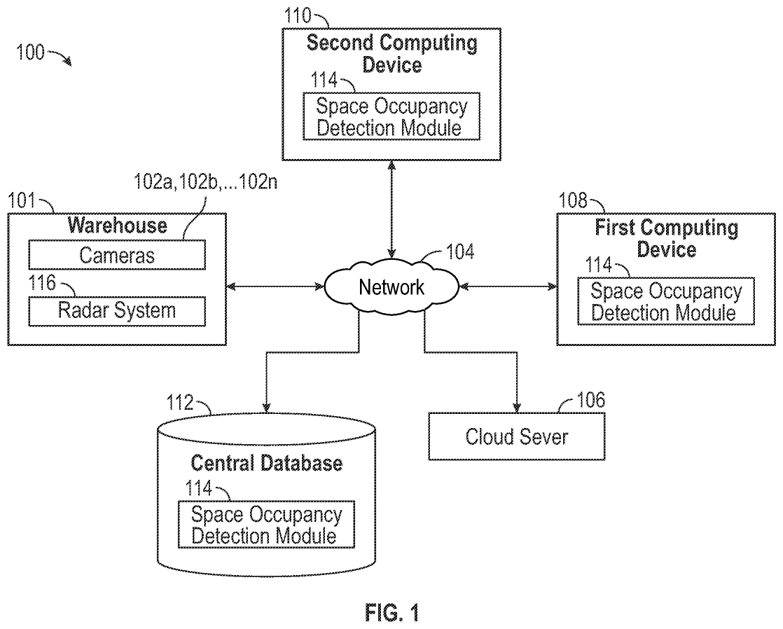

Referring to FIG. 1, FIG. 1 is a block diagram 100 representing a system in which aspects of the present disclosure can be implemented. Specifically, FIG. 1 depicts a schematic representation of the system for detecting real-time space occupancy of an inventory within a warehouse, in accordance with one or more exemplary embodiments. The system 100 includes a warehouse 101, cameras 102a, 102b, 102c . . . 102n, a network 104, a cloud server 106, a first computing device 108, a second computing device 110, and a central database 112. The first computing device 108, the second computing device 110 and the central database 112 may include a space occupancy detection module 114. The space occupancy detection module 114 may be programmed with an artificial intelligence and machine learning techniques using custom trained convolutional neural network (CNN) models to automate the process of detecting the amount of space utilized within the warehouse at any given point of time.

The first computing device 108 may be operated by a first user. The first user may include, but not limited to, warehouse management, teams, a manager, an employee, an operator, a worker, and so forth. The second computing device 110 may be located in a backroom at multiple locations. The multiple locations may include, but are not limited to, a warehouse, a server location, and so forth. The multiple locations may include one or more programmed computers and are in wired, wireless, direct, or networked communication (the network 104) with the cameras 102a, 102b, 102c . . . 102n. The cameras 102a, 102b, 102c . . . 102n may include, but is not limited to, three-dimensional cameras, thermal image cameras, infrared cameras, night vision cameras, varifocal cameras, and so forth. A physical layout of the warehouse 101 includes a loading and unloading zone, a storage area, and so forth. The inventory or cargo may include, but not limited to, different shapes, size, packings, and so forth. The warehouse 101 includes a radar system 116 configured to predict the space utilized and the depth information of the inventory or cargo. The radar system 116 includes a transmitter configured to produce electromagnetic waves, a transmitting antenna, a receiving antenna configured to transmit and receive radio waves. The radar system 116 includes a receiver and a processor configured to determine the properties of the inventory. The first computing device 108, the second computing device 110 and the central database 112 may be configured to receive the predicted space utilized and the depth information of the inventory or cargo using the radar system 116.

The network 104 may include, but is not limited to, an Ethernet, a wireless local area network (WLAN), or a wide area network (WAN), a Bluetooth low energy network, a ZigBee network, a Controller Area Network (CAN bus), a WIFI communication network e.g., the wireless high speed internet, or a combination of networks, a cellular service such as a 4G (e.g., LTE, mobile WiMAX) or 5G cellular data service, a RFID module, a NFC module, wired cables, such as the world-wide-web based Internet, or other types of networks may include Transport Control Protocol/Internet Protocol (TCP/IP) or device addresses (e.g. network-based MAC addresses, or those provided in a proprietary networking protocol, such as Modbus TCP, or by using appropriate data feeds to obtain data from various web services, including retrieving XML data from an HTTP address, then traversing the XML for a particular node) and the like without limiting the scope of the present disclosure.

Although the first and second computing devices 108, 110 are shown in FIG. 1, an embodiment of the system 100 may support any number of computing devices. The system 100 may support only one computing device (108 or 110). The computing devices 108, 110 may include, but are not limited to, a desktop computer, a personal mobile computing device such as a tablet computer, a laptop computer, or a netbook computer, a smartphone, a server, an augmented reality device, a virtual reality device, a digital media player, a piece of home entertainment equipment, backend servers hosting database 112 and other software, and the like. Each computing device 108, 110 supported by the system 100 is realized as a computer-implemented or computer-based device having the hardware or firmware, software, and/or processing logic needed to carry out the intelligent messaging techniques and computer-implemented methodologies described in more detail herein.

The space occupancy detection module 114 may be downloaded from the cloud server 106. For example, the space occupancy detection module 114 may be any suitable application downloaded from, GOOGLE PLAY® (for Google Android devices), Apple Inc.'s APP STORE® (for Apple devices, or any other suitable database). In some embodiments, the space occupancy detection module 114 may be software, firmware, or hardware that is integrated into the first computing device and the second computing device 108 and 110. The space occupancy detection module 114 which is accessed as mobile applications, web applications, software that offers the functionality of accessing mobile applications, and viewing/processing of interactive pages, for example, are implemented in the first and the second computing devices 108 and 110 as will be apparent to one skilled in the relevant arts by reading the disclosure provided herein.

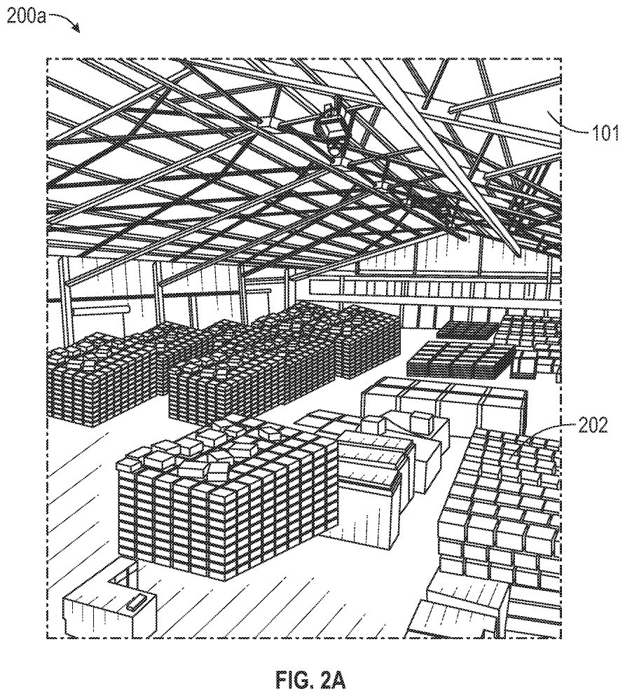

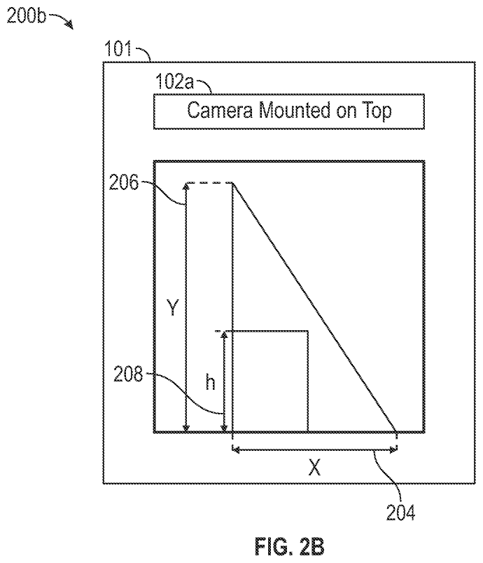

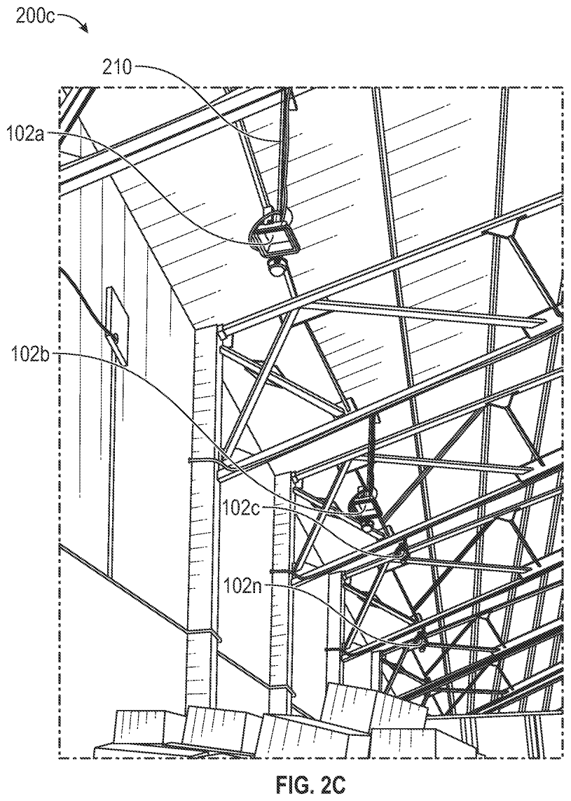

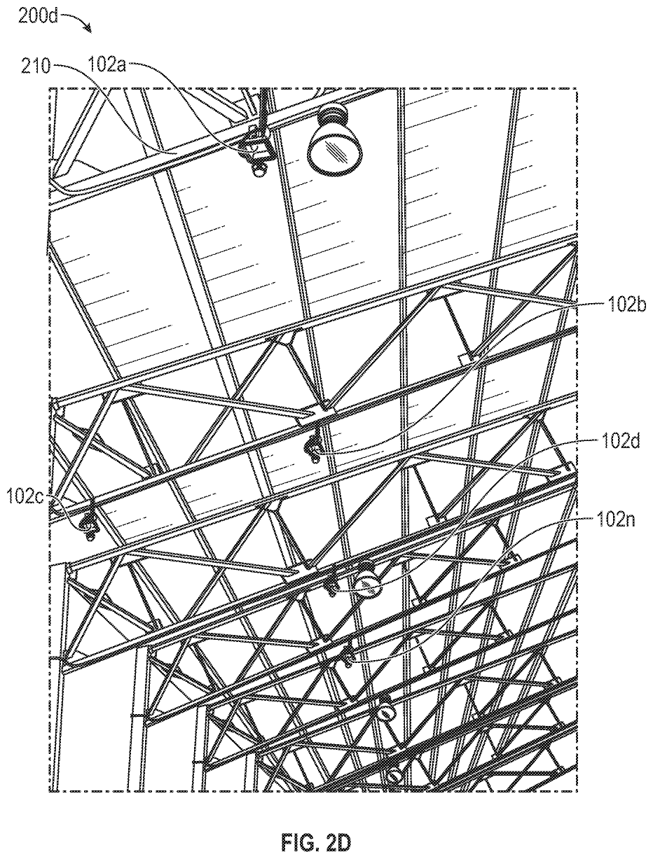

Referring to FIG. 2A, FIG. 2A is an example diagram 200a depicting a schematic representation of the warehouse, in accordance with one or more exemplary embodiments. The warehouse 200a includes an inventory or cargo 202. The inventory or cargo 202 may come in different shapes, size, packing, and so forth. The warehouse 101 may be designed for efficient use of existing and created space. The warehouse 101 may allow the team to work to maximum capacity at all times, and the inventory or cargo 202 may flow throughout the warehouse 101 as smoothly as possible. Accessibility is one key factor involved in the warehouse management. Teams may be able to store and retrieve the inventory or cargo 202 easily which reduces the touch points and handling time.

The cameras 102a, 102b, 102c . . . 102n may be arranged facing down from the roof in such a way that the complete area of the warehouse 101 is covered from the combination of all the camera views. The cameras 102a, 102b, 102c . . . 102n may be configured to capture the predetermined area within the warehouse 101 to obtain an image data. The image data may include, but not limited to, inventory images, goods images, cargo images, people images, empty space images, equipment images, object images, warehouse layout images, and so forth. The predetermined area may include, but not limited to, Field of View, distance from floor captured by the cameras 102a, 102b, 102c . . . 102n, and so forth. The cameras 102a, 102b, 102c . . . 102n may be positioned at selectable locations within the warehouse 101. The selectable locations may include, but not limited to, roof, walls, and so forth.

The cameras 102a, 102b, 102c . . . 102n may be configured to deliver the image data to the first computing device 108 and the second computing device 110 over the network 104. The space occupancy detection module 114 may be configured to sample the image data regular intervals on the first computing device 108 and the second computing device 110. The space occupancy detection module 114 may be configured to perform one or more image preprocessing techniques on the image data to detect the real-time space occupancy of the inventory within the warehouse. The space occupancy detection module 114 may be configured to determine the inventory kinds. The inventory kinds may include, but not limited to, one or more shapes, size, and packing of the inventory stored in the warehouse 101. The space occupancy detection module 114 is configured to determine a depth information of the inventory stored in the warehouse 101.

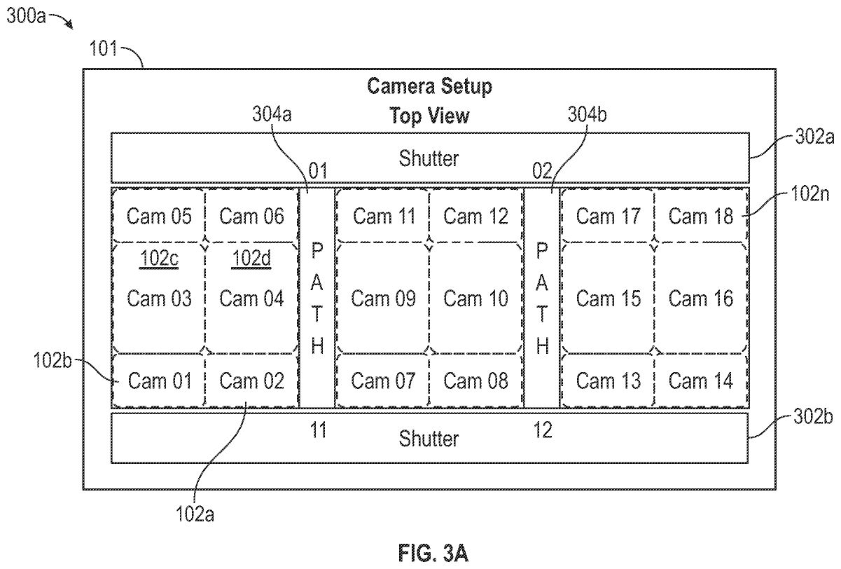

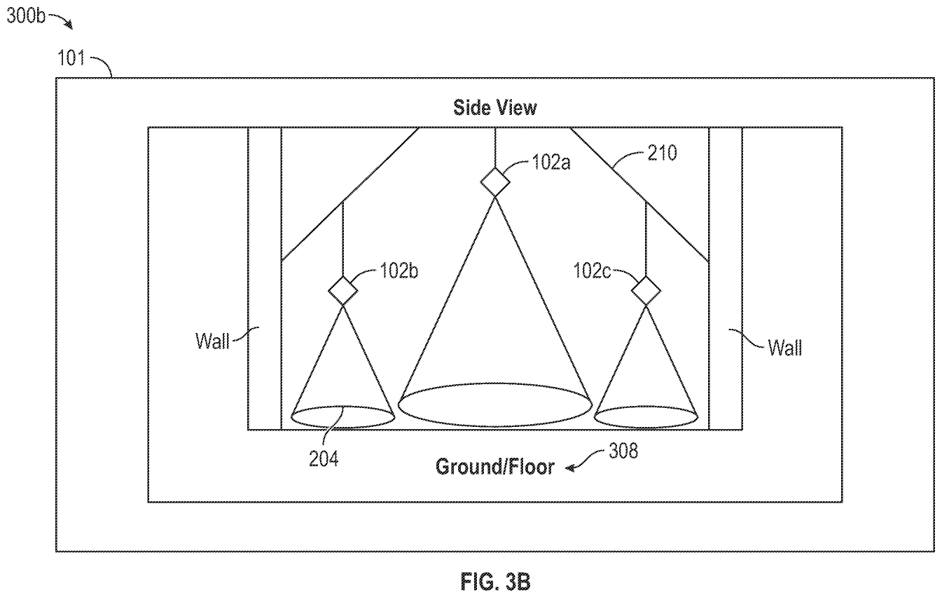

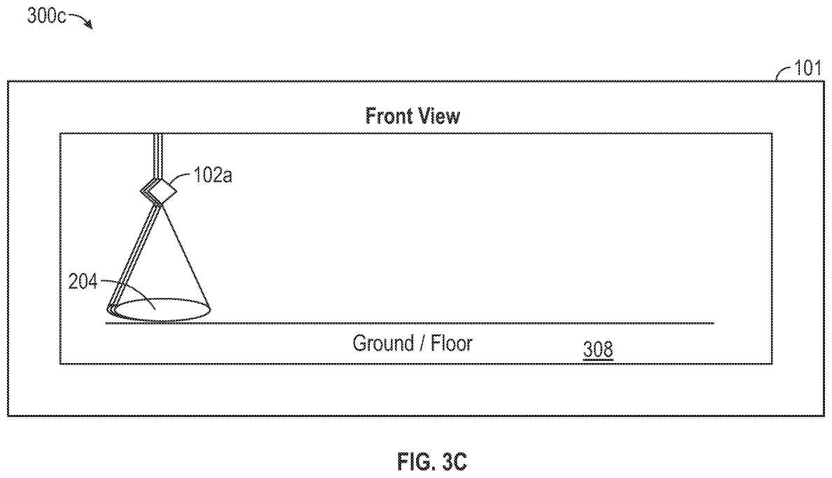

Referring to FIG. 2B, FIG. 2B is another example diagram 200b depicting a schematic representation of the predetermined area being covered by cameras in the warehouse 101, in accordance with one or more exemplary embodiments. The warehouse 200b includes the camera 102a, field of view (x) 204, height (y) 206, and maximum height (h) 208. The predetermined area being covered by the camera 102a is not the same all the time. The height 206 at which the camera 102b is being mounted and the field of view 204 define the ROI (Region of Interest). The ROI may get influenced as the camera 102a can be mounted at different heights. The view of the predetermined area covered by the camera 102a increases proportionately with the height 206 and affects the quality of the image data which causes issues in further process. Therefore, considering an optimal height where ROI for the camera 102a is more and also the image data is not distorted for the analysis. For example, the maximum height (h) 208 of the inventory or cargo 202 at any location doesn't exceed a predefined value. The coverage of the camera 102a may consider as the maximum area that is covered by the camera field of view (y, from the diagram) above ground (308, as shown in FIG. 3B) level.

Referring to FIG. 2C and FIG. 2D, FIG. 2C and FIG. 2D are example diagrams 200b and 200c depicting the warehouse 101, in accordance with one or more exemplary embodiments. The warehouse 200c and 200d include the cameras 102a, 102b, 102c, . . . 102n, iron beams 210. The cameras 102a, 102b, 102c . . . 102n may be motorized and move away from the ground (308, as shown in FIG. 3B) when the first user moved inside warehouse 101. The cameras 102a, 102b, 102c . . . 102n may be attached to the iron beams 210.

Referring to FIG. 3A, FIG. 3A, is an example diagram 300a depicting a top view of the cameras in the warehouse 101 shown in FIG. 1, in accordance with one or more exemplary embodiments. The diagram 300a depicts the warehouse 101, the cameras 102a, 102b, 102c . . . 102n, shutters 302a and 302b, and paths 304a and 304b. The shutters 302a and 302b may be configured to enable the first user to perform loading and unloading activities. The paths 304a and 304b may connect the shutters 302a and 302b that face each other. The cameras 102a, 102b, 102c . . . 102n may be fixed in such a way that covers the predetermined area in between these paths 304a and 304b. The cameras 102a, 102b, 102c . . . 102n near to the shutters 302a and 302b are a bit closer to the ground (308, as shown in FIG. 3B) as the iron beams 210 (shown in FIG. 2C, FIG. 2D) are inclined and mounting the cameras 102a, 102b, 102c . . . 102n using the beam for support. As the users move inside the warehouse 101, the camera 102a, 102b, 102c . . . 102n moves away from a ground (308, as shown in FIG. 3B) using a motor and the field of view 204 increases gradually.

Referring to FIG. 3B, FIG. 3B, is another example diagram 300b depicting a side view of the cameras in the warehouse 101 shown in FIG. 1, in accordance with one or more exemplary embodiments. The diagram 300b depicts the warehouse 101, cameras 102a, 102b, 102c . . . 102n, iron beams 210, a ground 308 and the field of view 204. As the users move inside the warehouse, the camera 102a, 102b, 102c . . . 102n moves away from the ground 308.

Referring to FIG. 3C, FIG. 3C, is another example diagram 300c depicting a front view of the cameras in the warehouse 101 shown in FIG. 1, in accordance with one or more exemplary embodiments. The diagram 300c includes the warehouse 101, camera 102a or 102b or 102c or . . . or 102n, field of view 204, and the floor or ground 308. The floor or ground 308 may be configured to place the inventory.

The cameras 102a or 102b or 102c or . . . 102n positioned at optimal heights configured to capture the predetermined area to obtain the image data. The image data may include inventory positioned on the floor/ground 308 within the warehouse 201 and the obtained image data is delivered to the first computing device 108 and the second computing device 110 over the network 104. The space occupancy detection module 114 may be configured to sample the frames of the image data at regular intervals and apply a few images preprocessing techniques on the first computing device 108 and the second computing device 110. The space occupancy detection module 114 may be configured to crop the ROI (region of interest) from the image data.

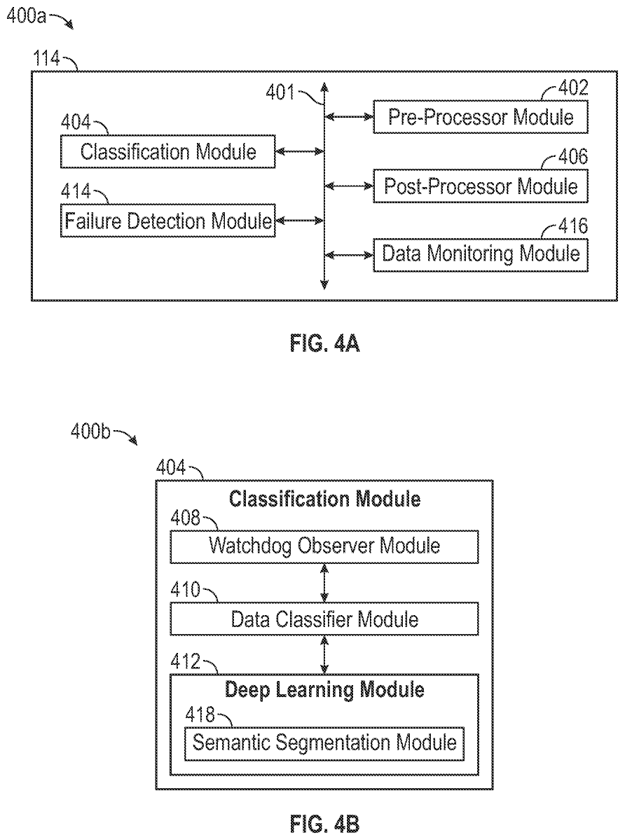

Referring to FIG. 4A, FIG. 4A is a block diagrams 400a depicting a schematic representation of the space occupancy detection module 114 shown in FIG. 1, in accordance with one or more exemplary embodiments. The space occupancy detection module 114 includes a bus 401, a pre-processor module 402, a classification module 404, a post-processor module 406, a failure detection module 414, and a data monitoring module 416. The pre-processor module 402 may be configured to read the image data captured by the cameras 102a, 102b, 102c, 102d . . . 102n and store the image data received from the cameras 102a, 102b, 102c, 102d . . . 102n at regular intervals. The pre-processor module 402 may be configured to time stamp the image data received from the cameras 102a, 102b, 102c, 102d . . . 102n at the specified time.

Referring to FIG. 4B, FIG. 4B is a block diagrams 400b depicting a schematic representation of the classification module 404 shown in FIG. 1, in accordance with one or more exemplary embodiments. The classification module 404 includes a watchdog observer module 408, a data classifier module 410, and a deep learning module 412.

The watchdog observer module 408 may be configured to continuously monitor an output from the pre-processor module 406 and append to a global list when there is new image data to access the global list and invoke the data classifier module 410. The watchdog observer module 408 may be configured to perform a few image preprocessing techniques before the image data delivered to the deep learning module 412. The data classifier module 410 may be configured to read the image data to perform size conversion to standard size. The data classifier module 410 may be configured to perform image preprocessing techniques. The data classifier module 410 may be configured to crop Region of Interest (ROI) from the image data and delivers to the deep learning module 412 for the prediction. The deep learning module 412 may include a semantic segmentation module 418 configured to categorize each pixel of the image data to multiple segmentation classes. The segmentation multiple classes may include, but not limited to, cargo, inventory, background, person, equipment, and so forth. The semantic segmentation module 418 may be configured to predict the amount of space utilized by the inventory from the multiple segmentation classes. The deep learning module 412 may be programmed with the deep neural networks, convolutional neural networks, machine learning and artificial intelligence techniques. The deep learning module 412 may be configured to predict the real-time space occupied by at least one of the inventory or cargo, equipment, people, and empty space within the warehouse from the image data. The predictions may include, but not limited to, the multiple segmentation classes, and the so forth. The predictions from the deep learning module 412 are saved to the file system along with a timestamp. The post-processor module 406 may be configured to stitch the complete mask for the image data. The post-processor module 406 may be configured the compute the occupancy statistics and map the result to the warehouse layout. The warehouse layout is maintained in a configuration file. The cloud server 106 is consumed by a visualization software module like dashboard and also interfaced with billing or financial systems for automatic invoicing to customers. The post-processor module 406 may be configured to use the predictions from the deep learning module 412 to map the predictions to the warehouse layout and delivers to the cloud server 106. The first computing device 108 and the second computing device 110 may be configured to access the cloud server 106 over the network 104 to view the real-time space occupancy by the inventory. The failure detection module 414 may be configured to monitor the running process and detect any failures to invoke appropriate actions. The failure detection module 414 may be configured to monitor the network nodes/devices (cameras, systems, routers) and detect any failures. The data monitoring module 416 may be configured to archive the previous image data regularly.

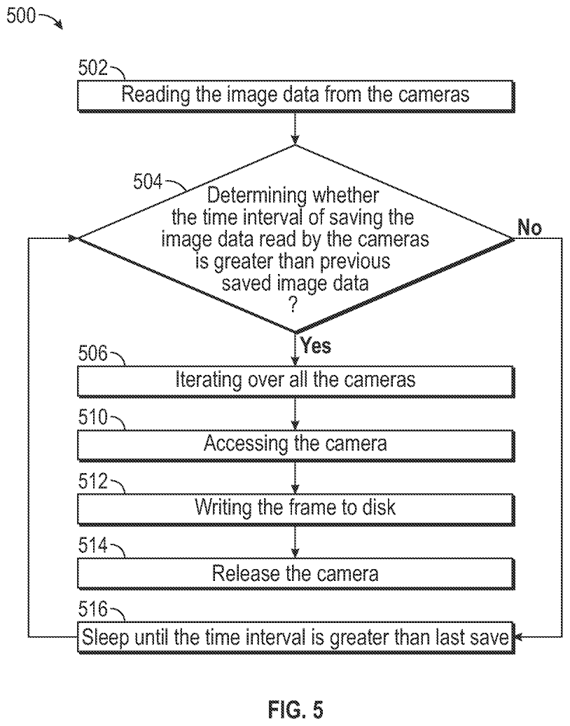

Referring to FIG. 5, FIG. 5 is another example of flow diagram 500 depicting a method of the pre-processor module, in accordance with one or more exemplary embodiments. The method 500 may be carried out in the context of the details of FIG. 1, FIG. 2A, FIG. 2B, FIG. 2C, FIG. 2D, FIG. 3A, FIG. 3B, FIG. 3C, FIG. 4A and FIG. 4B. However, the method 500 may also be carried out in any desired environment. Further, the aforementioned definitions may equally apply to the description below.

The method commences at step 502, reading the image data from the cameras. Determining whether the time interval of saving the image data read by the cameras is greater than previous saved image data, at step 504? If the answer at step 504 is yes, iterating over all the cameras, at step 506. Thereafter at step 510, accessing the camera. Thereafter at step 512, writing the frame to disk. Thereafter at step 514, releasing the camera. Thereafter the method reverts at step 504. If the answer at step 504 is No, the method continues at step 516, sleep until the time interval is greater than last save. Then, the method continues at step 504.

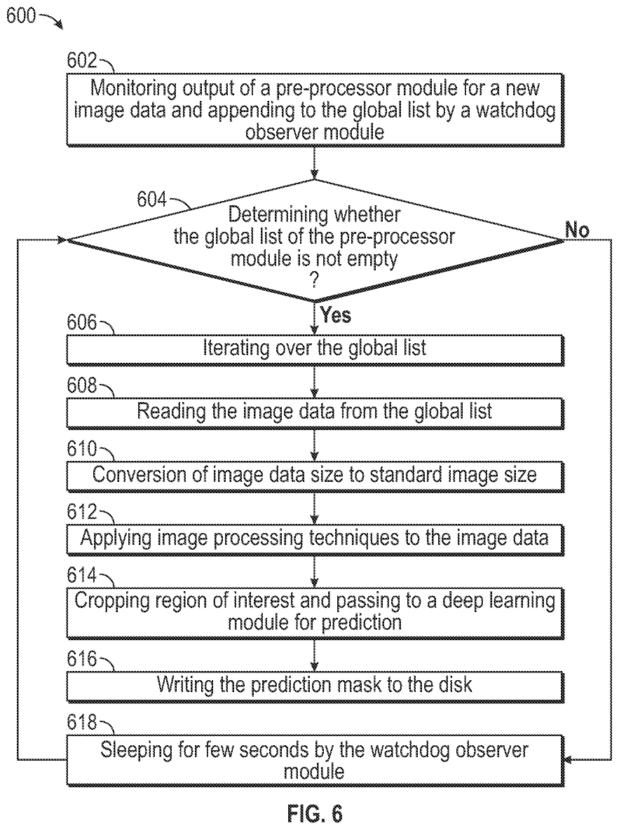

Referring to FIG. 6, FIG. 6 is another example of flow diagram 600 depicting a method of the data classifier module, in accordance with one or more exemplary embodiments. The method 600 may be carried out in the context of the details of FIG. 1, FIG. 2A, FIG. 2B, FIG. 2C, FIG. 2D, FIG. 3A, FIG. 3B, FIG. 3C, FIG. 4A, FIG. 4B, and FIG. 5. However, the method 600 may also be carried out in any desired environment. Further, the aforementioned definitions may equally apply to the description below.

The method commences at step 602, monitoring the output of the pre-processor module for a new image data and appending it to the global list by the watchdog observer module. Determining whether the global list of the pre-processor module is not empty, at step 604. If the answer at step 604 is yes, the method continues at step 606, iterating over the global list. Thereafter the method continues at step 608, reading the image data from the global list. Thereafter at step 610, conversion of image size to standard size. Thereafter the method continues at step 612, applying the image processing techniques to the image data. Thereafter at step 614, cropping the region of interest and passing to the deep learning model for prediction. Thereafter the method continues at step 616, writing the prediction mask to the disk. Thereafter the method reverts at step 604. If the answer at step 604 is No, the method continues at step 618, sleeping for few seconds by the watchdog observer module. Thereafter the method reverts at step 604.

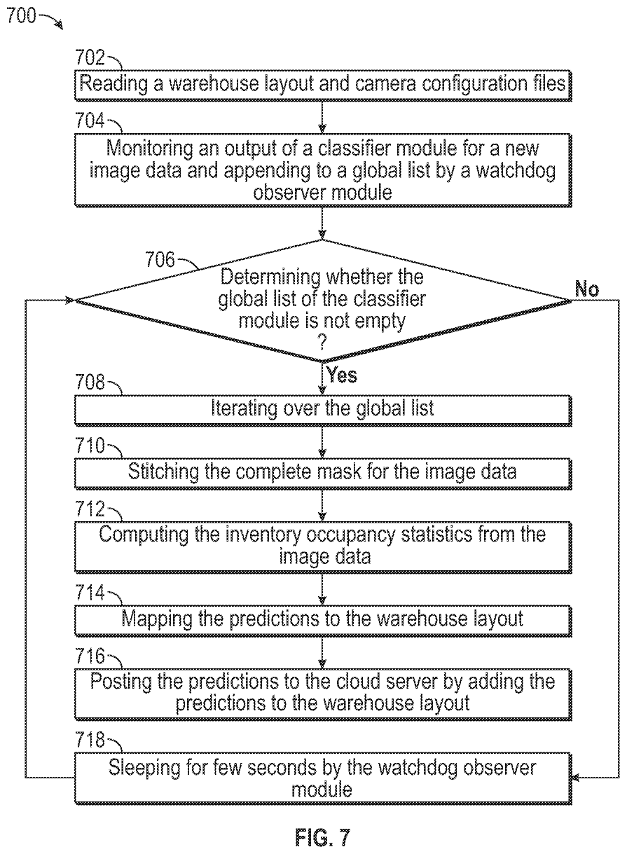

Referring to FIG. 7, FIG. 7 is another example of flow diagram 700 depicting a method of the post-processor module, in accordance with one or more exemplary embodiments. The method 700 may be carried out in the context of the details of FIG. 1, FIG. 2A, FIG. 2B, FIG. 2C, FIG. 2D, FIG. 3A, FIG. 3B, FIG. 3C, FIG. 4A, FIG. 4B, FIG. 5, and FIG. 6. However, the method 700 may also be carried out in any desired environment. Further, the aforementioned definitions may equally apply to the description below.

The method commences at step 702, reading the warehouse layout and camera configuration files. Thereafter at step 704, monitoring the output of the classifier module for a new image data and appending to the global list by the watchdog observer module. Determining whether the global list of the classifier module is not empty, at step 706. If the answer at step 706 is yes, the method continues at step 708, iterate over the global list. Thereafter at step 710, stitching the complete mask for the image data. Thereafter at step 712, computing the inventory occupancy statistics from the image data. Thereafter at step 714, mapping the predictions to the warehouse layout. Thereafter at step 716, posting the predictions to the cloud server. Thereafter the method reverts at step 706. If the answer at step 706 is No, the method continues at step 718, sleeping for few seconds by the watchdog observer module. Thereafter the method reverts at step 706.

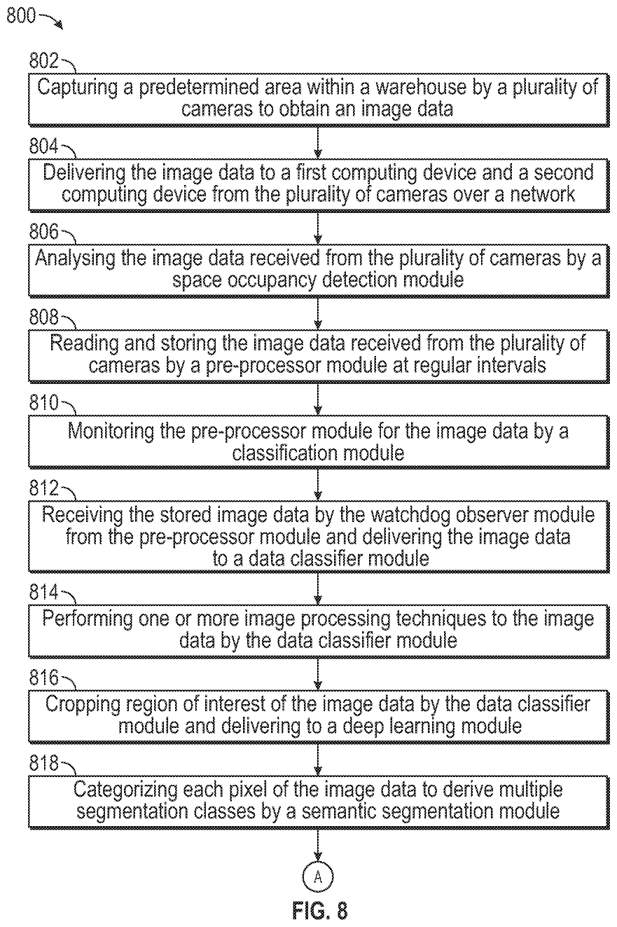

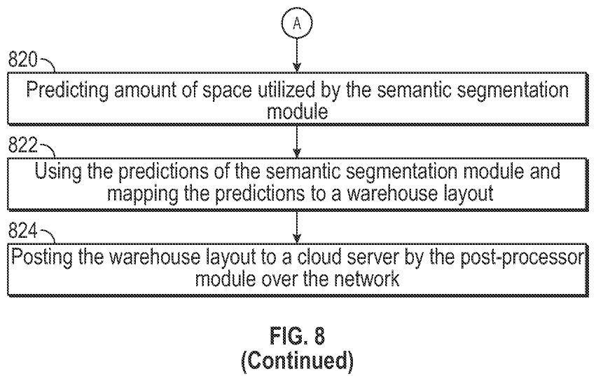

Referring to FIG. 8, FIG. 8 is another example of flow diagram 800 depicting a method for detecting real-time space occupancy of an inventory within a warehouse, in accordance with one or more exemplary embodiments. The method 800 may be carried out in the context of the details of FIG. 1, FIG. 2A, FIG. 2B, FIG. 2C, FIG. 2D, FIG. 3A, FIG. 3B, FIG. 3C, FIG. 4A, FIG. 4B, FIG. 5, FIG. 6, and FIG. 7. However, the method 800 may also be carried out in any desired environment. Further, the aforementioned definitions may equally apply to the description below.

The method commences at step 802, capturing the predetermined area within the warehouse by the plurality of cameras to obtain the image data. Thereafter at step 804, delivering the image data to the first computing device and the second computing device from the plurality of cameras over the network. Thereafter at step 806, analyzing the image data received from the plurality of cameras by the space occupancy detection module. Thereafter at step 808, reading and storing the image data received from the plurality of cameras by the pre-processor module at regular intervals. Thereafter at step 810, monitoring the pre-processor module for the image data by the classification module. Thereafter at step 812, receiving the stored image data by the watchdog observer module from the pre-processor module and delivering the image data to the data classifier module. Thereafter at step 814, performing the one or more image processing techniques to the image data by the data classifier module. Thereafter at step 816, cropping region of interest of the image data by the data classifier module and delivering to the deep learning module. Thereafter at step 818, categorizing each pixel of the image data to derive multiple segmentation classes by the semantic segmentation module. Thereafter at step 820, predicting amount of space utilized by the semantic segmentation module. Thereafter at step 822, using the predictions of the semantic segmentation module and mapping the predictions to the warehouse layout. Thereafter at step 824, posting the warehouse layout to the cloud server by the post-processor module over the network.

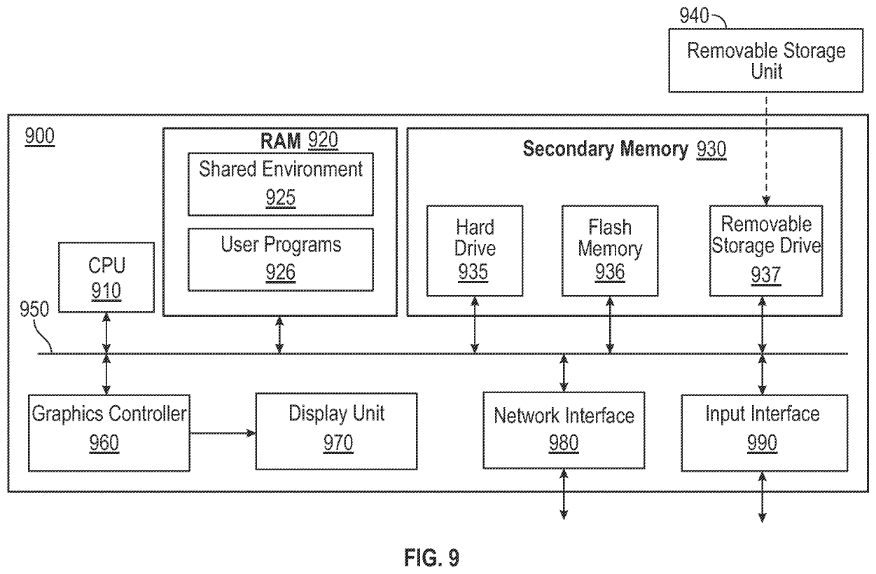

Referring to FIG. 9, FIG. 9 is a block diagram illustrating the details of digital processing system 900 in which various aspects of the present disclosure are operative by execution of appropriate software instructions. Digital processing system 900 may correspond to the first computing device 108 and the second computing device 110 (or any other system in which the various features disclosed above can be implemented).

Digital processing system 900 may contain one or more processors such as a central processing unit (CPU) 910, random access memory (RAM) 920, secondary memory 930, graphics controller 960, display unit 970, network interface 980, an input interface 990. All the components except display unit 970 may communicate with each other over communication path 950, which may contain several buses as is well known in the relevant arts. The components of FIG. 9 are described below in further detail.

CPU 910 may execute instructions stored in RAM 920 to provide several features of the present disclosure. CPU 910 may contain multiple processing units, with each processing unit potentially being designed for a specific task. Alternatively, CPU 910 may contain only a single general-purpose processing unit.

RAM 920 may receive instructions from secondary memory 930 using communication path 950. RAM 920 is shown currently containing software instructions, such as those used in threads and stacks, constituting shared environment 925 and/or user programs 926. Shared environment 925 includes operating systems, device drivers, virtual machines, etc., which provide a (common) run time environment for execution of user programs 926.

Graphics controller 960 generates display signals (e.g., in RGB format) to display unit 970 based on data/instructions received from CPU 910. Display unit 970 contains a display screen to display the images defined by the display signals. Input interface 990 may correspond to a keyboard and a pointing device (e.g., touch-pad, mouse) and may be used to provide inputs. Network interface 980 provides connectivity to a network (e.g., using Internet Protocol), and may be used to communicate with other systems (such as those shown in FIG. 1, a network 104) connected to the network 104.

Secondary memory 930 may contain hard drive 935, flash memory 936, and removable storage drive 937. Secondary memory 930 may store the data software instructions (e.g., for performing the actions noted above with respect to the Figures), which enable digital processing system 900 to provide several features in accordance with the present disclosure.

Some or all of the data and instructions may be provided on the removable storage unit 940, and the data and instructions may be read and provided by removable storage drive 937 to CPU 910. Floppy drive, magnetic tape drive, CD-ROM drive, DVD Drive, Flash memory, a removable memory chip (PCMCIA Card, EEPROM) are examples of such removable storage drive 937.

The removable storage unit 940 may be implemented using medium and storage format compatible with removable storage drive 937 such that removable storage drive 937 can read the data and instructions. Thus, removable storage unit 940 includes a computer readable (storage) medium having stored therein computer software and/or data. However, the computer (or machine, in general) readable medium can be in other forms (e.g., non-removable, random access, etc.).

In this document, the term “computer program product” is used to generally refer to the removable storage unit 940 or hard disk installed in hard drive 935. These computer program products are means for providing software to digital processing system 900. CPU 910 may retrieve the software instructions, and execute the instructions to provide various features of the present disclosure described above.

The term “storage media/medium” as used herein refers to any non-transitory media that store data and/or instructions that cause a machine to operate in a specific fashion. Such storage media may comprise non-volatile media and/or volatile media. Non-volatile media includes, for example, optical disks, magnetic disks, or solid-state drives, such as storage memory 930. Volatile media includes dynamic memory, such as RAM 920. Common forms of storage media include, for example, a floppy disk, a flexible disk, hard disk, solid-state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 950. Transmission media can also take the form of acoustic or light waves, such as those generated during radio-wave and infra-red data communications.

In an embodiment of the present disclosure, an automated system for detecting real-time space occupancy of inventory within a warehouse, comprising the plurality of cameras 102a, 102b, 102c . . . 102n configured to capture predetermined area within the warehouse 101 to obtain the image data, the plurality of cameras 102a, 102b, 102c . . . 102n configured to deliver the image data to the first computing device 108 and the second computing device 110 over the network 104. The space occupancy detection module 114 configured to analyse the image data received from the plurality of cameras 102a, 102b, 102c . . . 102n to the first computing device 108 and the second computing device 110, the space occupancy detection module 114 comprising the pre-processor module 402 configured to read the image data delivered by the plurality of cameras 102a, 102b, 102c . . . 102n and store the image data received from the plurality of cameras 102a, 102b, 102c . . . 102n at regular intervals.

In another embodiment of the present disclosure, the classification module 404 configured to monitor the pre-processor module 402 for the image data using the watchdog observer module 408, the watchdog observer module 408 configured to receive the stored image data from the pre-processor module 402 and deliver the image data to the data classifier module 410, the data classifier module 410 configured to perform one or more image processing techniques to the image data to classify an inventory kind stored in the predetermined area, the data classifier module configured to crop Region of Interest of the image data and deliver to the deep learning module, the deep learning module 412 comprising the semantic segmentation module 418 configured to categorize each pixel of the image data to derive the plurality of segmentation classes, the semantic segmentation module 418 configured to predict the amount of space utilized from the plurality of segmentation classes.

In another embodiment of the present disclosure, the post-processor module 402 configured to use one or more predictions of the semantic segmentation module 418 to map the one or more predictions to the warehouse layout and deliver the warehouse layout to the cloud server 106 over the network 104. The central database 112 configured to store the image data captured by the plurality of cameras 102a, 102b, 102c . . . 102n, the central database 112 configured to store the one or more inventory kinds, and the plurality of segmentation classes, the warehouse layout derived by the space occupancy detection module 114.

Reference throughout this specification to “one embodiment”, “an embodiment”, or similar language means that a particular feature, structure, or characteristic described in connection with the embodiment is included in at least one embodiment of the present disclosure. Thus, appearances of the phrases “in one embodiment”, “in an embodiment” and similar language throughout this specification may, but do not necessarily, all refer to the same embodiment.

Although the present disclosure has been described in terms of certain preferred embodiments and illustrations thereof, other embodiments and modifications to preferred embodiments may be possible that are within the principles and spirit of the invention. The above descriptions and figures are therefore to be regarded as illustrative and not restrictive.

Thus the scope of the present disclosure is defined by the appended claims and includes both combinations and sub-combinations of the various features described hereinabove as well as variations and modifications thereof, which would occur to persons skilled in the art upon reading the foregoing description.

We claim:

1. An automated system for detecting real-time space occupancy of inventory within a warehouse, comprising:
a plurality of cameras configured to capture a predetermined area within a warehouse to obtain an image data, the plurality of cameras configured to deliver the image data to a first computing device and a second computing device over a network;
a space occupancy detection module configured to analyse the image data received from the plurality of cameras to the first computing device and the second computing device, the space occupancy detection module comprising a pre-processor module configured to read the image data delivered by the plurality of cameras and store the image data received from the plurality of cameras at regular intervals;
a classification module configured to monitor the pre-processor module for the image data using a watchdog observer module, the watchdog observer module configured to receive the stored image data from the pre-processor module and deliver the image data to a data classifier module, the data classifier module configured to perform one or more image processing techniques to the image data to classify an inventory kind stored in the predetermined area, the data classifier module configured to crop Region of Interest of the image data and deliver to a deep learning module, whereby the deep learning module comprising a semantic segmentation module configured to categorize each pixel of the image data to derive a plurality of segmentation classes, the semantic segmentation module configured to predict the amount of space utilized from the plurality of segmentation classes;
a post-processor module configured to use one or more predictions of the semantic segmentation module to map the one or more predictions to a warehouse layout and deliver the warehouse layout to a cloud server over the network; and
a central database configured to store the image data captured by the plurality of cameras, the central database configured to store the one or more inventory kinds, and the plurality of segmentation classes, the warehouse layout derived by the space occupancy detection module.

2. The system of claim 1, wherein the space occupancy detection module is programmed with an artificial intelligence and machine learning techniques using custom trained convolutional neural network (CNN) models to automate the process of detecting the amount of space utilized within the warehouse at any given point of time.

3. The system of claim 1, wherein the space occupancy detection module is configured to perform one or more image processing techniques on the image data to detect the real-time space occupancy of an inventory within the warehouse.

4. The system of claim 1, wherein the space occupancy detection module is configured to determine a depth information of the inventory stored in the warehouse.

5. The system of claim 1, wherein the plurality of cameras is arranged facing down from a roof in such a way that a complete area of the warehouse is covered.

6. The system of claim 1, wherein the image data comprising one or more inventory images, one or more goods images, one or more cargo images, one or more people images, one or more empty space images, one or more equipment images, and one or more object images.

7. The system of claim 1, wherein the predetermined area comprising a field of view, and distance from a ground captured by the plurality of cameras.

8. The system of claim 1, wherein the space occupancy detection module is configured to sample one or more frames of the image data at regular intervals of time on the first computing device and the second computing device.

9. The system of claim 1, wherein the plurality of cameras is motor-powered and moves away from the ground when a first user enters inside the warehouse.

10. The system of claim 1, wherein the plurality of cameras is attached to one or more iron beams.

11. The system of claim 1, wherein the space occupancy detection module is configured to determine one or more shapes, size, and packing of the inventory stored in the warehouse.

12. The system of claim 1, wherein the space occupancy detection module comprising a failure detection module configured to monitor and detect one or more failures to perform appropriate actions.

13. The system of claim 1, wherein the failure detection module is configured to monitor the network, the plurality of cameras, the first computing device, the second computing device and detects one or more failures.

14. The system of claim 1, wherein the space occupancy detection module comprising a data monitoring module configured to archive the previous image data regularly.

15. The system of claim 1, wherein the space occupancy detection module is configured to enable the first user to access the cloud server on the first computing device over the network.

16. An automated system for detecting real-time space occupancy of inventory within a warehouse, comprising:
a plurality of cameras configured to capture a predetermined area within a warehouse to obtain an image data, the plurality of cameras configured to deliver the image data to a first computing device and a second computing device over a network; and
a space occupancy detection module configured to analyse the image data received from the plurality of cameras to the first computing device and the second computing device, the space occupancy detection module configured to read and to store the image data received from the plurality of cameras at regular intervals, the space occupancy detection module configured to crop region of interest of the image data and categorize each pixel of the image data to derive a plurality of segmentation classes, the space occupancy detection module configured to predict amount of space utilized from the plurality of segmentation classes; and one or more predictions are mapped to a warehouse layout, the space occupancy detection module configured to deliver the warehouse layout to a cloud server over the network.

17. The system of claim 16, wherein the space occupancy detection module is configured to perform one or more image processing techniques to the image data to classify an inventory kind stored in the predetermined area.

18. The system of claim 17, wherein the inventory kind comprising one or more shapes, size, and packing of the inventory stored in the warehouse.

19. The system of claim 16, wherein the space occupancy detection module is configured to enable a first user to access the cloud server on the first computing device over the network.

20. A method for detecting for detecting real-time space occupancy of inventory within a warehouse, comprising:
capturing a predetermined area within a warehouse by a plurality of cameras configured to obtain an image data;
delivering the image data to a first computing device and a second computing device from the plurality of cameras over a network;
analysing the image data received from the plurality of cameras by a space occupancy detection module;
reading and storing the image data received from the plurality of cameras by a pre-processor module at regular intervals;
monitoring the pre-processor module for the image data by a classification module;
receiving the stored image data by the watchdog observer module from the pre-processor module and delivering the image data to a data classifier module;
performing one or more image processing techniques to the image data by the data classifier module;
cropping Region of Interest of the image data by the data classifier module and delivering to a deep learning module;
categorizing one or more pixels of the image data to derive a plurality of segmentation classes by a semantic segmentation module;
predicting amount of space utilized by the semantic segmentation module from the plurality of segmentation classes;
using the predictions of the semantic segmentation module and mapping the predictions to a warehouse layout; and
delivering the warehouse layout to a cloud server by the post-processor module over the network.
